(19) United States
(12) Patent Application Publication
(10) Pub. No.: US 2013/0279710 A1
(43) Pub. Date: Oct. 24, 2013

(54) SYSTEMS AND METHODS FOR SENSING THE OPERATIONAL STATUS OF AN ACOUSTIC HORN

(71) Applicants: Tian Xuan Zhang, Overland Park, KS (US); David Michael Chapin, Cincinnati, OH (US)

(72) Inventors: Tian Xuan Zhang, Overland Park, KS (US); David Michael Chapin, Cincinnati, OH (US)

(21) Appl. No.: 13/451,074

(22) Filed: Apr. 19, 2012

(51) Int. Cl. H04R 29/00

(52) U.S. Cl. 381/59

(57) ABSTRACT

A system for sensing an operational status or level of performance of an acoustic horn makes use of a vibration sensor that is operatively coupled to the driver of the acoustic horn. The sensor can be an accelerometer. The sensor outputs a vibration signal when the acoustic horn is operating. Characteristics of the vibration signal are compared to threshold values or to patterns to determine the operational status or level of performance of the acoustic horn.

### BACKGROUND OF THE INVENTION

Acoustic horns typically include a driver or sound generating device that is coupled to a horn which provides an acoustic impedence match between the sound generating device and free air. This has the effect of maximizing the efficiency with which sounds waves generated by the sound generating device are transferred into free air.

Sounds waves in their simplest form are pressure waves that travel through a medium. Various uses for acoustic horns exist today. Those uses include emitting sound waves as a signaling device to alert people to danger or damage. An acoustic horn can also emit sound waves to clean a surface of debris. In many circumstances, especially if acoustic horns are located in remote areas or are used for critical purposes, it is important for operators to know when the output of an acoustic horn is starting to degrade, or that the acoustic horn is not operating at all. Regular scheduled maintenance of the driver and horn can help to abate operational concerns, but the need exists for accurate, immediate feedback of horn operation.

Various different systems for sensing how well an acoustic horn is operating have been proposed. In most existing systems, a sound pressure sensor senses pressure waves generated by the acoustic horn within the horn structure itself, or from a location outside of or downstream from the horn. The sound pressure sensor is typically a microphone or some other pressure sensing device. Unfortunately, such sound pressure sensors can be relatively expensive, and they can be somewhat fragile. Also, the accuracy and efficiency of such a sound pressure sensor can degrade over time.

These sound pressure sensors may also be exposed to harsh and caustic conditions. By their nature, the sound pressure sensors must have a clear, open path to the horn. The medium between the horn and the sound pressure sensor can change drastically in temperature, density, and contamination within a given time period, which can greatly affect the signal output by the sensor. And because the signals can vary considerably, detecting degraded performance can be difficult or impossible. As a result, in many instances it is only possible to determine whether an acoustic horn is operating. It can be impossible to determine the current level of performance.

### BRIEF DESCRIPTION OF THE INVENTION

In one aspect, the invention may be embodied in a method of monitoring the performance of an acoustic horn which includes a step of sensing vibrations of an acoustic horn while the acoustic horn is activated with a sensor that outputs a vibration signal indicative of the sensed vibrations. The method also includes steps of comparing the vibration signal to at least one threshold value or pattern, and generating a report signal based on a result of the comparing step.

In another aspect, the invention may be embodied in a system for monitoring the performance of an acoustic horn that includes means for sensing vibrations of an acoustic horn while the acoustic horn is activated, wherein the sensing means outputs a vibration signal indicative of the sensed vibrations. The system also includes means for comparing the vibration signal to at least one threshold value or pattern, and means for generating a report signal based on a result of the comparing step.

In another aspect, the invention may be embodied in a system that includes a vibration sensor that senses vibrations of an acoustic horn while the acoustic horn is activated, wherein the vibration sensor outputs a vibration signal indicative of the sensed vibrations. The system also includes a comparison unit that compares the vibration signal to at least one threshold value or pattern, and a report unit that generates a report signal based on information generated by the comparison unit.

### BRIEF DESCRIPTION OF THE DRAWINGS

FIG. 1 is a diagram of a system for sensing an operational condition of an acoustic horn;

FIG. 2 is a block diagram illustrating elements of a controller of the system illustrated in FIG. 1;

FIG. 3 is a diagram illustrating a vibration signal that is output by a sensor of the system illustrated in FIG. 1; and

FIG. 4 is a flow chart illustrating steps of a method of sensing the operational status of an acoustic horn.

### DETAILED DESCRIPTION OF PREFERRED EMBODIMENTS

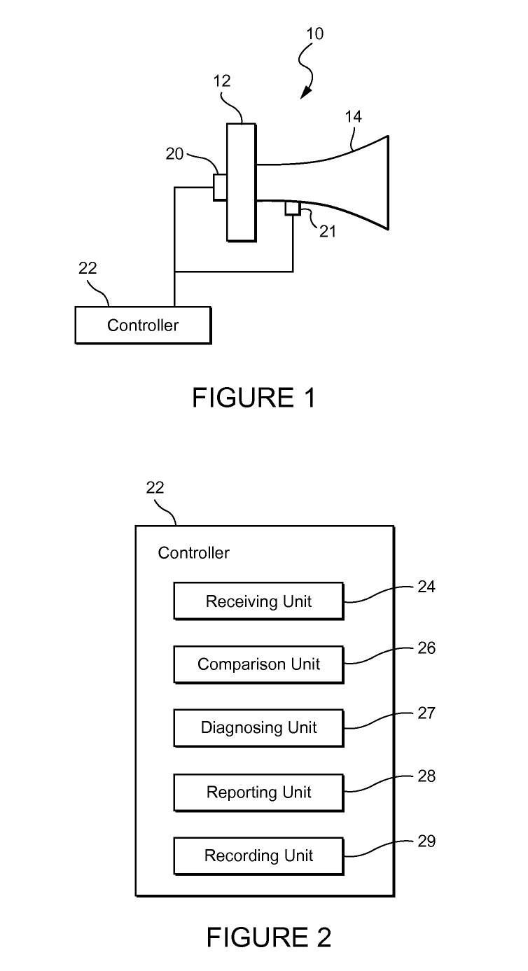

FIG. 1 shows a typical acoustic horn 10, which includes a driver 12 and a horn 14. The driver 12 creates sound pressure waves, and the horn 14 provides an acoustic impedence match between the driver 12 and free air. The driver 12 typically includes a diaphragm that vibrates to create sound pressure waves. Various different mechanisms can be used to cause the diaphragm to vibrate in a controlled fashion to generate the desired sound pressure waves. However, because the diaphragm is mounted in a housing of the driver 12, whenever the diaphragm is vibrating to produce sound pressure waves, the housing of the driver 12 also vibrates, albeit less than the diaphragm itself.

A system for monitoring the performance or operational status of the acoustic horn, and for diagnosing problems, makes use of one or more vibration sensors 20, 21, which are operationally mounted on the acoustic horn. In some embodiments, a vibration sensor 20 is mounted on the housing of the driver 12. In other embodiments, a vibration sensor 21 may be mounted on the horn 14. Some embodiments may only include a single vibration sensor, while other embodiments may include multiple vibration sensors.

When a vibration sensor 20 is mounted on the housing of the driver 12, the vibration sensor 20 outputs a vibration signal indicative of the vibration of the driver 12. The vibration signal may include both an amplitude and a frequency.

In some embodiments, the vibration sensors 20, 21 may be accelerometers. Low cost, durable accelerometers which could be used as the sensors 20, 21 are widely commercially available. In alternate embodiments, other types of sensing devices that are capable of sensing vibration could be used instead of an accelerometer. Regardless of the type of sensor that is used, the sensors 20, 21 output a vibration signal indicative of the vibrations which are generated when the acoustic horn 10 is operating.

The vibration sensors 20, 21 can be attached to the acoustic horn 10 via any suitable fastening means. For example, the vibration sensor could be attached to a portion of the acoustic horn 10 via an adhesive, or via a mechanical fastener such a screw or bolt. Further, a bracket or other mounting device may be provided on the acoustic horn 10 to receive and hold the vibration sensors 20, 21.

Each vibration sensor is operationally coupled to a controller 22 that receives the vibration signal generated by each vibration sensor 20, 21. In some embodiments, a wire or cable may run from each vibration sensor 20, 21 to the controller 22. In alternate embodiments, the vibration sensors may output wireless signals that are received by the controller 22. In this type of an embodiment, each vibration sensor 20, 21 may be coupled to a wireless transmitter, and the controller 22 may be coupled to a wireless receiver. The signals output by each vibration sensors would be provided to a wireless transmitter, and the wireless transmitter would send the signal to the wireless receiver. The wireless receiver would then provide the signal to the controller 22.

FIG. 2 illustrates some elements of the controller 22. As shown in FIG. 2, the controller includes a receiving unit 24 that receives a vibration signal from at least one vibration sensor. The controller also includes a comparison unit 26 that compares one or more characteristics of the vibration signal to one or more predetermined threshold values or patterns. In some embodiments, simply determining how one or more characteristics of the vibration signal compare to a threshold value may provide all the required information.

In some embodiments, the controller may also include a diagnosing unit 27. The diagnosing unit 27 may compare one or more aspects of the vibration signal to threshold values or to patterns to determine whether the acoustic horn is operating properly. If the diagnosing unit 27 determines that the acoustic horn is not operating properly, the diagnosing unit 27 may be able to determine what is causing the problem by examining the vibration signals from one or more vibration sensors that are attached to the acoustic horn.

The comparison unit 26 and/or the diagnosing unit 27 may compare a vibration signal from one or more vibration sensors to a baseline established for that particular acoustic horn when the acoustic horn is first installed or when the vibration sensors are first installed on the acoustic horn. This would allow real world testing to determine what characteristics of the vibration signal should be considered “normal.” If testing is conducted upon installation, to establish a baseline level for the signal from the vibration sensor, the real world conditions that exist for that particular acoustic horn can be taken into account.

In other embodiments, the comparison unit 26 and/or the diagnosing unit 27 may compare a vibration signal from one or more vibration sensors to baseline values that have been established from testing multiple different acoustic horns in similar installation environments.

The diagnosing unit 27 may employ predictive analytics, based upon how similar acoustic horns have performed in the past, to determine the operational status of the acoustic horn. If past history shows that a particular pattern of the vibration signal indicates that the acoustic horn is about to fail, the diagnosing unit 27 can alert maintenance personnel of the need to take corrective action before the acoustic horn actually fails.

The controller 22 also includes a reporting unit 28 that generates a report signal indicative of the level of performance or the operational state of the acoustic horn. The report signal may also indicate the cause of any problems that have been detected. The report signal is based on information generated by the comparison unit 26 and/or the diagnosing unit 27.

In some embodiments, the controller may further include a recording unit 29. The recording unit 29 could record all or selected portions of the vibration signals generated by one or more vibration sensors. The recording unit 29 may also record the signal that is applied to the driver 12 of the acoustic horn, so that the signal output by one or more of the vibration sensors can be compared to the signal applied to the driver, which may facilitate the diagnosis of a problem or the determination of the operational status of the acoustic horn.

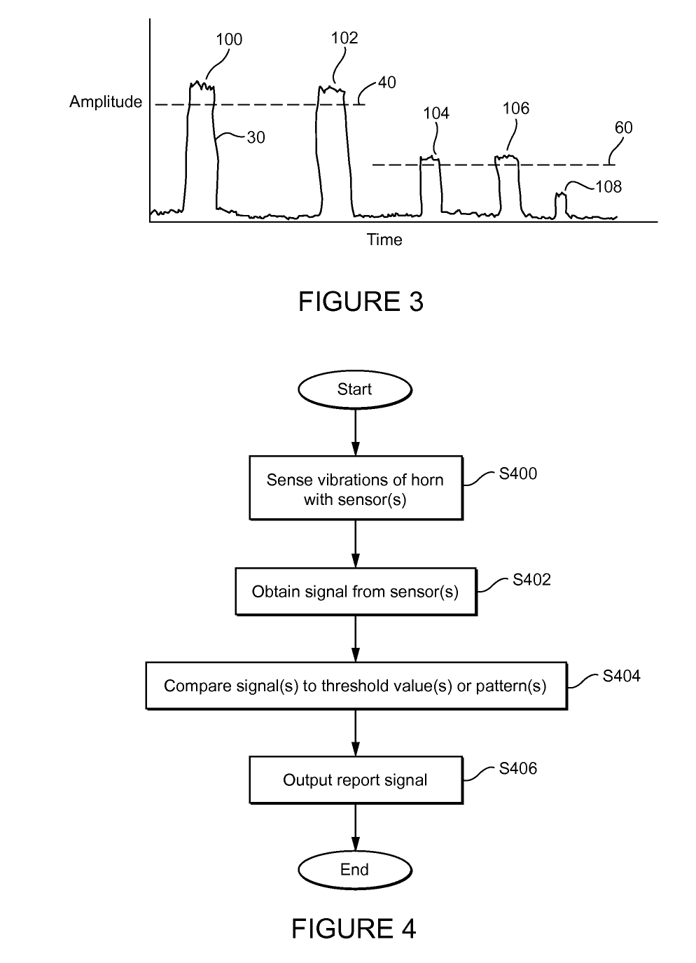

FIG. 3 illustrates a vibration signal 30 that might be generated by a vibration sensor. FIG. 3 shows the amplitude of the vibration signal over time. As is apparent from FIG. 3, when the acoustic horn 10 is not operating, the vibration signal 30 has a very small amplitude, basically representing a background noise level. However, when the acoustic horn is activated, and the acoustic horn vibrates, the amplitude of the vibration signal 30 becomes relatively large. The vibration signal 30 in FIG. 3 includes five high amplitude segments 100, 102, 104, 106 and 108 which indicate five corresponding points in time when the acoustic horn was in operation.

FIG. 3 also shows two different threshold values 40 and 60, which are represented by dashed lines. The amplitude of the vibration signal 30 is compared to the two threshold values 40, 60 to determine the level of performance or the operational status of the acoustic horn. For example, if the amplitude of the vibration signal 30 is greater than the first threshold value 40, the acoustic horn is deemed to be operating properly. FIG. 3 illustrates that the vibration signal 30 is above the first threshold value 40 during the first two times 100 and 102 that the acoustic horn was operating.

If the amplitude of the vibration signal 30 falls below the first threshold value 40, but is still greater than the second threshold value 60, the acoustic horn is deemed to be operating in an impaired or degraded fashion. FIG. 3 illustrates that the amplitude of the vibration signal 30 fell into this range during the third and fourth times 104, 106 that the acoustic horn was operating.

If the amplitude of the vibration signal 30 falls below the second threshold value 60, the performance of the acoustic horn is deemed to have fallen to an unacceptably low level. FIG. 3 illustrates that the amplitude of the vibration signal 30 fell below the second threshold value 60 during the fifth time 108 that the acoustic horn was operating. This would indicate that the acoustic horn should be repaired or replaced.

In some embodiments, the comparison unit 26 of the controller 22 compares the amplitude of a vibration signal generated by a vibration sensor to predetermined threshold values, as illustrated in FIG. 3, to determine the level of performance or the operational status of the acoustic horn. The information generated by the comparison unit 26 is then used by the reporting unit 28 to generate a report signal indicative of the determined level of performance or operational status.

Although the example given above included the use of two different predetermined threshold values, in alternate embodiments, only a single threshold value might be used. So long as the amplitude of the vibration signal remains above the threshold value when the acoustic horn is operating, the performance would be deemed acceptable. If the amplitude falls below the threshold value, the performance would be deemed unacceptable.

As noted above, the threshold values(s) to which a vibration signal is compared could be established by conducting real world testing. The threshold values(s) could also be automatically set by the controller based on analytic tolls. Likewise, the amplitude of the vibration signal could be compared to more than two threshold values to make finer determinations about how well the acoustic horn is operating. Predictive analytics can be used to chart the predicted remaining life of an acoustic horn to aid in forecasting the need for replacement parts and the time when they should be replaced to avoid complete failure of the acoustic horn.

Also, in some embodiments, the acoustic horn might be configured to output different types of sounds or different volume levels. If this is the case, the threshold value(s) to which the vibration signal is compared would be adjusted accordingly.

Also, the above examples involved comparing the amplitude of the vibration signal to one or more threshold values. In alternate embodiments, the frequency of the vibration signal might instead be compared to one or more threshold frequency values.

For example, in some embodiments, if the frequency of the vibration signal is greater than or lower than a threshold frequency value, the performance of the acoustic horn would be determined to be acceptable. Otherwise, the performance would be deemed unacceptable. Likewise, the performance might be deemed acceptable only if the frequency of the vibration signal falls between two threshold frequency values. If the frequency of the vibration signal is greater than the larger threshold frequency value or lower than the lower threshold frequency value, the performance would be deemed unacceptable.

In still other embodiments, both the amplitude and the frequency of the vibration signal may be compared to threshold values to determine the level of performance of the acoustic horn. Also, in still other embodiments, other characteristics of the vibration signal may be compared to one or more threshold values to determine the level of performance of the acoustic horn.

In some embodiments, characteristics of the vibration signal may be compared to characteristics of a drive signal applied to the driver 12 of the acoustic horn 10 to determine the level of performance or the operational status of the acoustic horn. For example, if aspects of the vibration signal, such as its waveform, closely match corresponding aspects the drive signal, the acoustic horn would be deemed to be providing acceptable performance. If the sensed aspects of the vibration signal do not closely match corresponding aspects of the drive signal, the acoustic horn would be deemed to be providing unacceptable or poor performance.

When two or more vibration sensors are provided on an acoustic horn, the vibration signals generated by all of the vibration sensors may be used together to determine the operational status of the acoustic horn, or to diagnose a problem. For example, if a first vibration sensor attached to the driver housing provides a good vibration signal when the acoustic horn is activated, but a second vibration sensor on the horn portion provides little or no signal when the horn is activated, this information could indicate that the driver is operating properly, by that the horn portion is blocked or otherwise impaired.

A diagnosing unit 27 of a controller could compare the signals generated by one or more vibration sensors to predetermined patterns to determine the operational status of an acoustic horn, and/or to diagnose particular problems or faults. The predetermined patterns could be stored in a database that is accessible to the controller 22 of the diagnosing unit 27.

In some embodiments, the reporting unit 28 may be capable of generating a display signal that drives a display screen. In this sort of an embodiment, the display screen could illustrate the pattern of a vibration sensor signal, as shown in FIG. 3. The display may also illustrate the pattern of a drive signal applied to the driver of the acoustic horn, to thereby facilitate a comparison of the drive signal to the vibration sensor signal.

FIG. 4 illustrates steps of a method of determining the operational status or performance of an acoustic horn. The method begins in step S400 where one or more vibration sensors sense vibration of a driver of an acoustic horn and output one or more vibration signals. In step S402, a controller obtains the vibration signal(s). In step S404, one or more aspects of the vibration signal(s) are compared to one or more threshold values or to one or more patterns. Then, based on the result of step S404, a report signal indicative of the operational status, or level of performance of the acoustic horn, or a diagnosis of a fault, is output in step S406.

While the invention has been described in connection with what is presently considered to be the most practical and preferred embodiments, it is to be understood that the invention is not to be limited to the disclosed embodiments, but on the contrary, is intended to cover various modifications and equivalent arrangements which are encompassed within the spirit and scope of the appended claims.

What is claimed is:

1. A method of monitoring the performance of an acoustic horn, comprising:
sensing vibrations of an acoustic horn while the acoustic horn is activated with a sensor that outputs a vibration signal indicative of the sensed vibrations;
comparing the vibration signal to at least one threshold value or pattern; and
generating a report signal based on a result of the comparing step.

2. The method of claim 1, wherein the sensing step comprises sensing vibrations of the acoustic horn driver housing with an accelerometer.

3. The method of claim 1, wherein the sensing step comprises sensing vibrations of the acoustic horn driver with an accelerometer that is mounted on the acoustic horn driver.

4. The method of claim 1, wherein the comparing step comprises determining whether an amplitude of the vibration signal is greater than a first threshold value.

5. The method of claim 4, wherein if the amplitude of the vibration signal is greater than the first threshold value, the generating step comprises generating a report signal that indicates that the acoustic horn is operating normally, and wherein if the amplitude of the vibration signal is smaller than the first threshold value, the generating step comprises generating a report signal that indicates that the acoustic horn is not operating normally.

6. The method of claim 4, wherein if the amplitude of the vibration signal is smaller than the first threshold value, the comparing step further comprises determining whether the amplitude of the vibration signal is greater than a second threshold value.

7. The method of claim 6, wherein if the amplitude of the vibration signal is less than the first threshold value and greater than the second threshold value, the generating step comprises generating a report signal that indicates that the horn is operating with less than optimal performance, and wherein if the amplitude of the vibration signal is less than the second threshold value, the generating step comprises generating a report signal that indicates that the horn is malfunctioning.

8. The method of claim 1, wherein the comparing step comprises determining whether a frequency of the vibration signal is greater than a first threshold frequency.

9. The method of claim 1, wherein the sensing step comprises sensing the vibration of an acoustic horn with a plurality of vibration sensors that output a corresponding plurality of vibration signals.

10. The method of claim 9, wherein the comparing step comprises comparing the vibration signals output by the plurality of vibration sensors to at least one predetermined pattern.

11. A system for monitoring the performance of an acoustic horn, comprising:
means for sensing vibrations of an acoustic horn while the acoustic horn is activated, wherein the sensing means outputs a vibration signal indicative of the sensed vibrations;
means for comparing the vibration signal to at least one threshold value or pattern; and
means for generating a report signal based on a result of the comparing step.

12. A system for monitoring the performance of an acoustic horn, comprising:
a vibration sensor that senses vibrations of an acoustic horn while the acoustic horn is activated and that outputs a vibration signal indicative of the sensed vibrations;
a comparison unit that compares the vibration signal to at least one threshold value or pattern; and
a report unit that generates a report signal based on information generated by the comparison unit.

13. The system of claim 12, wherein the vibration sensor comprises an accelerometer.

14. The system of claim 12, wherein the vibration sensor comprises an accelerometer that is configured to be operatively mounted on an acoustic horn driver of an acoustic horn.

15. The system of claim 12, wherein the vibration sensor comprises a plurality of vibration sensors that output a corresponding plurality of vibration signals.

16. The system of claim 12, wherein the comparison unit is configured to compare an amplitude of the vibration signal to at least one threshold value or pattern.

17. The system of claim 16, wherein the comparison unit is configured to determine if the amplitude of the vibration signal is greater than first and second threshold values.

18. The system of claim 17, wherein the report unit is configured to output a report signal indicating that the acoustic horn is operating normally if the amplitude of the vibration signal is greater than the first threshold value, wherein the report unit is configured to output a report signal indicating that the acoustic horn is operating in an impaired fashion if the amplitude of the vibration signal is smaller than the first threshold value but greater than the second threshold value, and wherein the report unit is configured to output a report signal indicating that the acoustic horn is malfunctioning if the amplitude of the vibration signal is smaller than the second threshold value

19. The system of claim 12, wherein the comparison unit is configured to compare a frequency of the vibration signal to at least one threshold value or pattern.

20. The system of claim 12, wherein the comparison unit is configured to diagnose specific faults based on the vibration signal.
